(19) United States
(12) Patent Application Publication
(10) Pub. No.: US 2010/0277282 A1
(43) Pub. Date: Nov. 4, 2010

(54) RADIO FREQUENCY IDENTIFICATION TAG

(76) Inventor: Hee-Bok Kang, Gyeonggi-do (KR)

Correspondence Address: IP & T Law Firm PLC, 7700 Little River Turnpike, Suite 207, Annandale, VA, 22003, US

(21) Appl. No.: 12/493,518

(22) Filed: Jun. 29, 2009

(30) Foreign Application Priority Data
Apr. 30, 2009 (KR) 10-2009-0038567

(51) Int. Cl. H04B 7/00

(52) U.S. Cl. 340/10.1

(57) ABSTRACT

A radio frequency identification (RFID) tag includes an RFID block; a battery; and a control unit configured to control to supply an internal power for use in the RFID block by using a radio frequency (RF) signal or by using a battery voltage, which is a voltage of the battery.

### CROSS-REFERENCE TO RELATED APPLICATIONS

The present application claims priority of Korean Patent Application No. 10-2009-0038567, filed on Apr. 30, 2009, the disclosure of which is incorporated herein by reference in its entirety.

### BACKGROUND OF THE INVENTION

The present invention relates to a radio frequency identification (RFID) system, and more particularly, to an RFID tag of the RFID system. Generally, an RFID system includes an RFID reader configured to analyze and interpret an RFID tag, which includes its own tag information, application software and a network. The RFID reader generates a radio frequency (RF) signal to recognize the RFID tag and outputs the RF signal through an antenna. The RFID tag receives the RF signal outputted from the RFID reader. The RFID tag transmits a response signal having the tag information in response to the received RF signal. The RFID reader analyzes the response signal and interprets the tag information of the RFID tag.

The RFID tag includes a transponder chip and an antenna, which are produced by a general semiconductor device. RFID tags are divided into a passive type and an active type according to operation power supply characteristics. The passive-type RFID tag operates with energy supplied from the radio frequency signal from the RFID reader without an internal power. The active-type RFID tag includes a battery dedicated to the RFID tag, and the active-type RFID tag operates with the power supplied from the battery.

### SUMMARY OF THE INVENTION

An embodiment of the present invention is directed to provide a radio frequency identification (RFID) tag having the advantages of both passive-type RFID tag and active-type RFID tag.

In accordance with an aspect of the present invention, there is provided a radio frequency identification (RFID) tag, including: an RFID block; a battery; and a control unit configured to control to supply an internal power for use in the RFID block by using a radio frequency (RF) signal or by using a battery voltage, which is a voltage of the battery.

The control unit may include a radio frequency voltage detection circuit configured to detect a voltage level of an RF voltage generated from the RF signal received from an exterior and output a plurality of selection signals corresponding to the voltage level of the RF voltage; a first switch configured to receive a first selection signal among the plurality of the selection signals and supply the RF voltage as the internal power in response to the first selection signal; and a second switch configured to receive a second selection signal among the plurality of the selection signals and the battery voltage as the internal power in response to the second selection signal.

The control unit may further includes a third switch configured to receive a third selection signal among the plurality of the selection signals and charge the battery by using the RF voltage in response to the third selection signal; and a fourth switch configured to receive a fourth selection signal among the plurality of the selection signals and regulate the voltage level of the RF voltage in response to the fourth selection signal.

The RFID block may include an analog block configured to generate a power signal and internal processing signals by using an analog signal from an antenna; a digital block configured to receive the power signal and the internal processing signals from the analog block and perform digital operations; and a memory block configured to store data under control of the digital block.

The analog block may include a voltage multiplier configured to generate the RF voltage by using the RF signal from the antenna; a demodulator configured to generate internal processing signals based on the RF signal from the antenna and output the internal processing signals to the digital block; a modulator configured to modulate a response signal transmitted from the digital block and transmit the modulated signal to the antenna; a power-on reset unit configured to receive the power signal and output a power-on reset signal to the digital block; and a clock generating unit configured to receive the power signal and output a clock signal to the digital block.

The control unit may determine an operation mode of the RFID block and supply the corresponding internal power with the RFID block, and the operation mode includes a battery-power activation mode in which the battery is used voltage as the internal power, an RF-power activation mode in which the RF voltage is used as the internal power, a battery charging mode in which the battery is charged by using the RF voltage, and a voltage regulation mode in which a voltage level of the RF voltage is maintained.

The control unit may determine the operation mode of the RFID block as the battery-power activation mode, the RF-power activation mode, the battery charging mode and the voltage regulation mode in sequence, as the voltage level of the RF voltage increases.

The RF voltage detection circuit may include a reference voltage generating unit configured to generate a reference voltage; a comparison voltage generating unit configured to generate a comparison voltage; an RF voltage comparing unit configured to compare the reference voltage and the comparison voltage; and an output unit configured to output a comparison result in the RF voltage comparing unit.

The RF voltage comparison unit may include a differential amplifier.

In accordance with another aspect of the present invention, there is provided a radio frequency identification (RFID) tag, including: an RFID block; a battery; a voltage multiplier configured to generate a radio frequency (RF) voltage by using an RF signal received from an exterior; an RF voltage detection circuit configured to detect a voltage level of the RF voltage; and an internal voltage control circuit configured to control to supply the RF voltage or a battery voltage, which is a voltage of the battery, as an internal power with the RFID block according to a detection result of the RF voltage detection circuit.

The internal voltage control circuit may include a switch control driving unit configured to generate first to fourth selection signals according to the detection result of the RF voltage detection circuit; a first switch configured to receive the first selection signal and supply the RF voltage as the internal power; and a second switch configured to receive the second selection signal and supply the battery voltage as the internal power.

The internal voltage control circuit may further include: a third switch configured to receive the third selection signal and charge the battery with the RF voltage; and a fourth switch configured to receive the fourth selection signal and regulate the voltage level of the RF voltage. The internal voltage control circuit may determine an operation mode of the RFID block and supply the corresponding internal power with the RFID block, and the operation mode includes a battery-power activation mode in which the battery is used voltage as the internal power, an RF-power activation mode in which the RF voltage is used as the internal power, a battery charging mode in which the battery is charged by using the RF voltage, and a voltage regulation mode in which a voltage level of the RF voltage is maintained.

The internal voltage control circuit may determine the operation mode of the RFID block as the battery-power activation mode, the RF-power activation mode, the battery charging mode and the voltage regulation mode in sequence, as the voltage level of the RF voltage increases.

### BRIEF DESCRIPTION OF THE DRAWINGS

FIG. 1 is a block diagram illustrating a radio frequency identification (RFID) tag in accordance with an embodiment of the present invention.

FIG. 2 is a block diagram illustrating a switch control unit shown in FIG. 1.

FIG. 3 is a diagram illustrating an operation mode of an RFID tag shown in FIG. 1.

FIG. 4 is a diagram illustrating a truth table of a switch control unit shown in FIG. 1.

FIG. 5 is a block diagram illustrating a radio frequency voltage detection circuit shown in FIG. 2.

FIG. 6 is a graph showing an operation of a radio frequency voltage detection circuit shown in FIG. 5.

### DESCRIPTION OF SPECIFIC EMBODIMENTS

Other objects and advantages of the present invention can be understood by the following description, and become apparent with reference to the embodiments of the present invention.

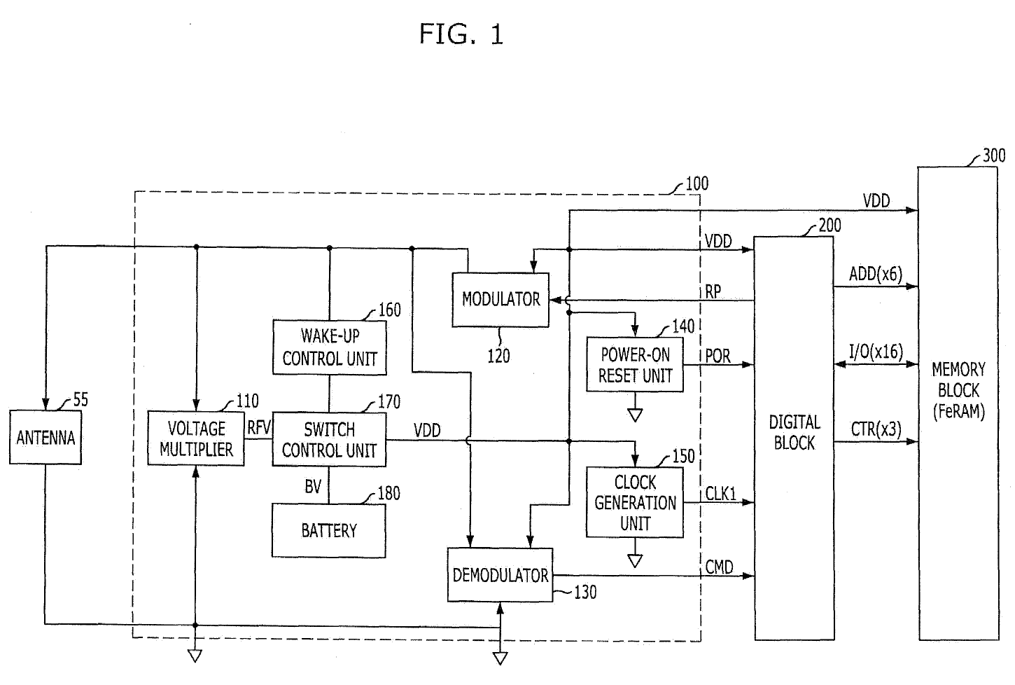

FIG. 1 is a block diagram illustrating a radio frequency identification (RFID) tag in accordance with an embodiment of the present invention.

Referring to FIG. 1, the RFID tag includes an antenna 55, an analog block 100, a digital block 200 and a memory block 300. The antenna 55 receives an RF signal during an RFID read operation or an RFID write operation (not shown) and transmits the RF signal to the analog block 100. The analog block 100 includes a voltage multiplier 110, a modulator 120, a demodulator 130, a power-on reset unit 140, a clock generation unit 150, a wake-up control unit 160, a switch control unit 170 and a battery 180.

The voltage multiplier 110 outputs a voltage RFV used in the RFID tag, and the RFV is generated by the frequency of the RF signal transmitted from the antenna. The modulator 120 modulates a response signal RP received from the digital block 200, and transmits the modulated signal to the antenna 55. The demodulator 130 receives a voltage VDD from the voltage multiplier 110 and the RF signal from the antenna, detects a command signal CMD and outputs the command signal CMD to the digital block 200.

The power-on reset unit 140 detects the voltages VDD of the voltage multiplier 110 and outputs a power on signal POR for controlling the reset operation to the digital block 200. The clock generation unit 150 receives the voltage VDD of the voltage multiplier 110, generates a clock signal CLK1 for controlling operations of the digital block 200 and outputs the clock signal CLK1 to the digital block 200.

The wake-up control unit 160 is a circuit for controlling a power down mode into a standby mode.

The switch control unit 170 is a circuit for controlling internal power. The switch control unit 170 generates the voltages VDD by using the RF voltage RFV received from exterior and uses the VDD as the internal power, or uses the battery 180 as the internal power. The switch control unit 170 uses a battery voltage BV supplied from the battery 180 as the internal power of the RFID tag at low voltage. Also, the switch control unit 170 uses the voltage supplied by the RF signal as the internal power of the RFID tag when voltage is higher than a predetermined voltage level. When the voltage supplied by the RF signal is used as the internal power of the RFID tag, the switch control unit 170 generates the voltage VDD by using the voltage RFV supplied from the voltage multiplier 110 and outputs the VDD.

The digital block 200 receives the voltage VDD, the power-on reset signal POR, the clock signal CLK1 and the command signal CMD from the analog block 100, and outputs the response signal RP to the modulator 120 of the analog block 100. The digital block 200 outputs an address signal ADD, input/output data I/O and control signal CTR to the memory block 300. The memory block includes a plurality of non-volatile ferroelectric memory cells (FeRAM).

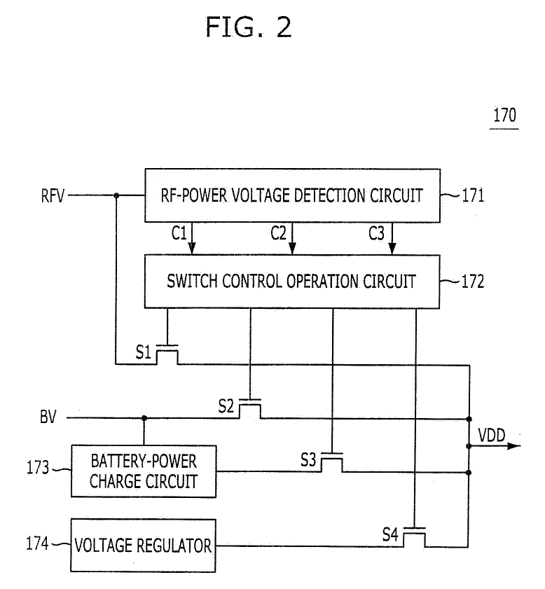

FIG. 2 is a block diagram illustrating a switch control unit shown in FIG. 1.

Referring to FIG. 2, the switch control unit 170 includes an RF-power voltage detection circuit 171, a switch control operation circuit 172, a plurality of switches S1 to S4, a battery-power charge circuit 173 and a voltage regulator 174.

The RF-power voltage detection circuit 171 detects a voltage level of the RF voltage RFV and outputs signals C1 to C3 corresponding to the voltage level of the RF voltage RFV. The switch control operation circuit 172 decodes the output signals C1 to C3 from the RF-power voltage detection circuit 171 and controls the plurality of switches S1 to S4 based on the decoding results. The battery-power charge circuit 173 is a circuit for charging the battery 180 to supply a battery voltage BV. The voltage regulator 174 is circuit for controlling a voltage regulation mode.

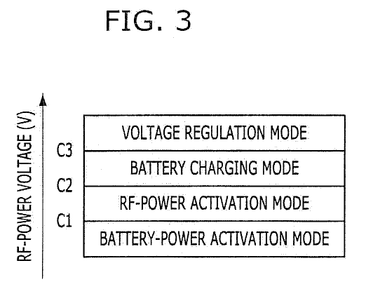

FIG. 3 is a diagram illustrating an operation mode of the RFID tag shown in FIG. 1.

Referring to FIG. 3, the operation mode of the RFID tag in accordance with the embodiment of the present invention includes a battery-power activation mode in which the battery voltage is used as the internal power, an RF-power activation mode in which the RF voltage is used as the internal power, a battery charging mode in which the battery is charged by using the RF voltage, and a voltage regulation mode in which a voltage level of the RF voltage is maintained. The operation mode is determined by using output signals C1 to C3 from the RF-power voltage detection circuit 171. The voltage levels of reference values for changing a mode are increased in a sequence of the battery-power activation mode, the RF-power activation mode, the battery charging mode and the voltage regulation mode.

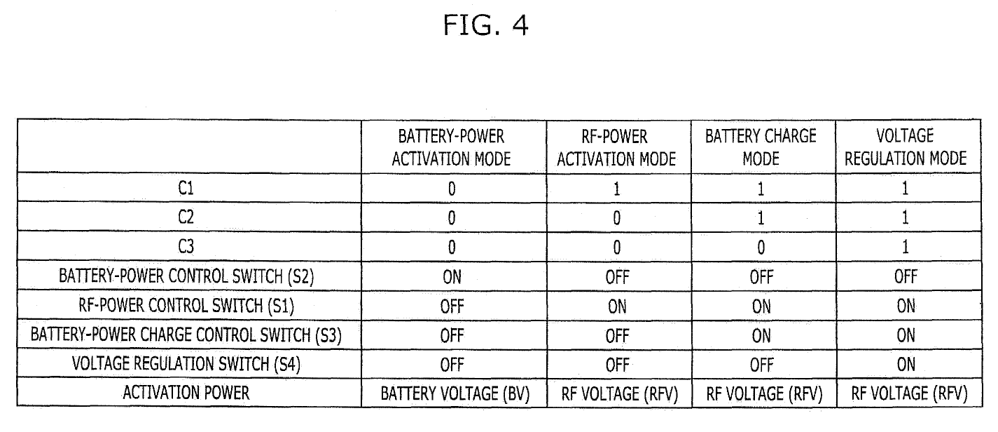

FIG. 4 is a diagram illustrating a truth table of a switch control unit shown in FIG. 1.

Referring to FIG. 4, a mode is determined among the battery-power activation mode, the RF-power activation mode, the battery charging mode and the voltage regulation mode according to truth values of signals C1 to C3 outputted from the RF-power voltage detection circuit 171. FIG. 4 represents activated switches among the plurality of switches S1 to S4 and whether the used power is the battery-power or the RF-power according to each mode.

For example, in the battery-power activation mode, all signals C1 to C3 are low level signals ‘0’, and only a battery-power control switch S2 is turned on. Thus, an internal voltage node VDD is connected to a battery voltage BV.

In the RF-power activation mode, only signal C1 is a high level signal ‘1’, and the others C2 and C3 are low level signals. Thus, an RF-power control switch St is only turned on, and the internal voltage node VDD is connected to an RF voltage RFV.

In the battery charging mode, signals C1 and C2 are high level signals and a signal C3 is a low level signal, and the RF-power control switch St and a battery-power charge control switch S3 are turned on. Thus, the internal voltage node VDD is connected to the RF voltage RFV.

In the voltage regulation mode, signals C1 to C3 are high level signals, and the RF-power control switch S1, the battery-power charge control switch S3 and a voltage regulation switch S4 are turned on. Thus, the internal voltage node VDD is connected to the RF voltage RFV.

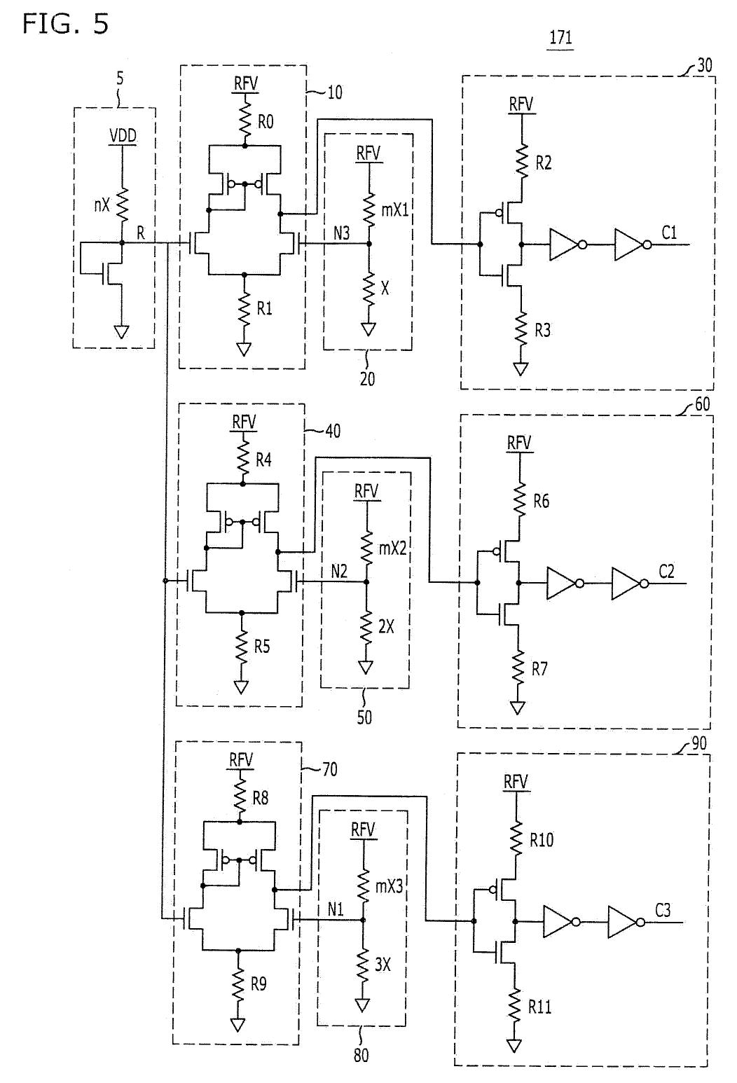

FIG. 5 is a block diagram illustrating a radio frequency voltage detection circuit shown in FIG. 2.

Referring to FIG. 5, the RF voltage detection circuit 171 includes a reference voltage generating unit 5, a first RF voltage comparing unit 10, a second RF voltage comparing unit 40, a third RF voltage comparing unit 70, a first comparison voltage generating unit 20, a second comparison voltage generating unit 50, a third comparison voltage generating unit 80, a first signal output unit 30, a second signal output unit 60 and a third signal output unit 90.

The first RF voltage comparing unit 10, the second RF voltage comparing unit 40 and the third RF voltage comparing unit 70 have the same configuration as shown in FIG. 5. In the embodiment of the present invention, the first to third RF voltage comparing units are configured to be differential amplifiers.

The first comparison voltage generating unit 20, the second comparison voltage generating unit 50 and the third comparison voltage generating unit 80 have the same configuration as shown in FIG. 5. Voltage levels of the comparison voltages N1 to N3 are determined by resistor values mX1, mX2, mX3, X, 2X and 3X.

The first signal output unit 30, the second signal output unit 60 and the third signal output unit 90 are the same configuration as shown in FIG. 5. The first to third signal output units 30, 60 and 90 output a signal supplied from corresponding RF voltage comparing unit.

The reference voltage generating unit 5 includes a resistor nX and a MOS transistor and generates a reference voltage R, and the first to third comparison voltage generating units 20, 50 and 80 include resistors. Also, various circuit configurations of the first to third comparison voltage generating units 20, 50 and 80 may be possible.

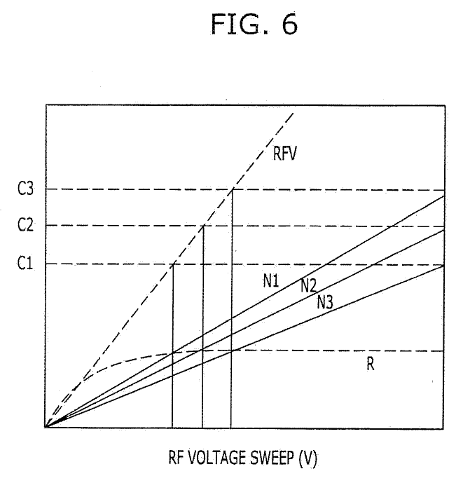

FIG. 6 is a graph showing an operation of a radio frequency voltage detection circuit shown in FIG. 5.

As shown in FIG. 6, in the RF voltage detection circuit, voltage level of a reference voltage R generated in the reference voltage generating unit 5 and comparison voltages N1 to N3 outputted from the first to third comparison voltage generating unit 20, 50 and 80 vary according to the voltage level of the RF voltage RFV. Each of the comparison voltages N1 to N3 is compared with the reference voltage R according to the RF voltage RFV, and signals C1 to C3 outputted from the first signal output unit 30, the second signal output unit 60 and the third signal output unit 90, respectively, are activated or deactivated based on the corresponding comparison result.

As described above, the RFID tag of the present invention includes an internal battery. The RFID tag uses a battery voltage as an internal power or an RF voltage supplied from the exterior as the internal power based on the control of the switch control unit 170. The internal voltage may be determined by a voltage level of the RF voltage, and the internal voltage may be determined by a certain reference voltage. Also, the battery may be charged by using the RF voltage.

Furthermore, the RFID tag of the present invention uses the battery voltage or the RF voltage based on the voltage level of the RF voltage. When the voltage level of the RF voltage is higher than a first voltage level, the battery charge operation is performed. Also, when the voltage level of the RF voltage is higher than a second voltage level, the RFID tag is operated as a regulation mode holding a predetermined voltage level.

Moreover, the RFID tag may use the battery voltage as an internal power before a wake-up signal is inputted. The wake-up signal is a signal inputted from the exterior for activating the RFID tag. When the wake-up signal is inputted, the RFID tag may use the RF voltage as the internal power. Also, it may operate reversely. Furthermore, the RFID may use only one voltage as the internal power for certain usage.

As described above, since the RFID tag of the present invention includes the internal battery, and the various power supplying methods may be possible based on the control of the switch control unit 170, the RFID tag may be used effectively. Thus, the RFID tag may be used longer than the conventional RFID tag, its use may be made to be more diverse.

According to the present invention, the RFID tag selectively uses one power between an internal battery and a power voltage supplied from the exterior, the operation time of the RFID may be extended. Also, since the RFID tag may charge the internal battery, life cycle of the RFID tag may be extended.

While the present invention has been described with respect to the specific embodiments, it will be apparent to those skilled in the art that various changes and modifications may be made without departing from the spirit and scope of the invention as defined in the following claims.

What is claimed is:

1. A radio frequency identification (RFID) tag, comprising:
an RFID block;
a battery; and
a control unit configured to control to supply an internal power for use in the RFID block by using a radio frequency (RF) signal or by using a battery voltage, which is a voltage of the battery.

2. The RFID tag of claim 1, wherein the control unit includes:
a radio frequency voltage detection circuit configured to detect a voltage level of an RF voltage generated from the RF signal received from an exterior and output a plurality of selection signals corresponding to the voltage level of the RF voltage;
a first switch configured to receive a first selection signal among the plurality of the selection signals and supply the RF voltage as the internal power in response to the first selection signal; and
a second switch configured to receive a second selection signal among the plurality of the selection signals and the battery voltage as the internal power in response to the second selection signal.

3. The RFID tag of claim 2, wherein the control unit further includes:
a third switch configured to receive a third selection signal among the plurality of the selection signals and charge the battery by using the RF voltage in response to the third selection signal; and
a fourth switch configured to receive a fourth selection signal among the plurality of the selection signals and regulate the voltage level of the RF voltage in response to the fourth selection signal.

4. The RFID tag of claim 1, wherein the RFID block includes:
an analog block configured to generate a power signal and internal processing signals by using an analog signal from an antenna;
a digital block configured to receive the power signal and the internal processing signals from the analog block and perform digital operations; and
a memory block configured to store data under control of the digital block.

5. The RFID tag of claim 4, wherein the analog block includes:
a voltage multiplier configured to generate the RF voltage by using the RF signal from the antenna;
a demodulator configured to generate internal processing signals based on the RF signal from the antenna and output the internal processing signals to the digital block;
a modulator configured to modulate a response signal transmitted from the digital block and transmit the modulated signal to the antenna;
a power-on reset unit configured to receive the power signal and output a power-on reset signal to the digital block; and
a clock generating unit configured to receive the power signal and output a clock signal to the digital block.

6. The RFID tag of claim 2, wherein the control unit determines an operation mode of the RFID block and supplies the corresponding internal power with the RFID block, and the operation mode includes a battery-power activation mode in which the battery is used voltage as the internal power, an RF-power activation mode in which the RF voltage is used as the internal power, a battery charging mode in which the battery is charged by using the RF voltage, and a voltage regulation mode in which a voltage level of the RF voltage is maintained.

7. The RFID tag of claim 6, wherein the control unit determines the operation mode of the RFID block as the battery-power activation mode, the RF-power activation mode, the battery charging mode and the voltage regulation mode in sequence, as the voltage level of the RF voltage increases.

8. The RFID tag of claim 2, wherein the RF voltage detection circuit includes:
a reference voltage generating unit configured to generate a reference voltage;
a comparison voltage generating unit configured to generate a comparison voltage;
an RF voltage comparing unit configured to compare the reference voltage and the comparison voltage; and
an output unit configured to output a comparison result in the RF voltage comparing unit.

9. The RFID tag of claim 8, wherein the RF voltage comparison unit includes a differential amplifier.

10. A radio frequency identification (RFID) tag, comprising:
an RFID block;
a battery;
a voltage multiplier configured to generate a radio frequency (RF) voltage by using an RF signal received from an exterior;
an RF voltage detection circuit configured to detect a voltage level of the RF voltage; and
an internal voltage control circuit configured to control to supply the RF voltage or a battery voltage, which is a voltage of the battery, as an internal power with the RFID block according to a detection result of the RF voltage detection circuit.

11. The RFID tag of claim 10, wherein the internal voltage control circuit includes:
a switch control driving unit configured to generate first to fourth selection signals according to the detection result of the RF voltage detection circuit;
a first switch configured to receive the first selection signal and supply the RF voltage as the internal power; and
a second switch configured to receive the second selection signal and supply the battery voltage as the internal power.

12. The RFID tag of claim 11, wherein the internal voltage control circuit further includes:
a third switch configured to receive the third selection signal and charge the battery with the RF voltage; and
a fourth switch configured to receive the fourth selection signal and regulate the voltage level of the RF voltage.

13. The RFID tag of claim 10, wherein the RFID block includes:
an analog block configured to generate a power signal and internal processing signals by using an analog signal from an antenna;
a digital block configured to receive the power signal and the internal processing signals from the analog block and perform digital operations; and
a memory block configured to store data under control of the digital block.

14. The RFID tag of claim 13, wherein the analog block includes:
a voltage multiplier configured to generate the RF voltage by using the RF signal from the antenna;
a demodulator configured to generate internal processing signals based on the RF signal from the antenna and output the internal processing signals to the digital block;
a modulator configured to modulate a response signal RP transmitted from the digital block and transmit the modulated signal to the antenna;
a power-on reset unit configured to receive the power signal and output a power-on reset signal to the digital block; and
a clock generating unit configured to receive the power signal and output a clock signal to the digital block.

15. The RFID tag of claim 10, wherein the internal voltage control circuit determines an operation mode of the RFID block and supplies the corresponding internal power with the RFID block, and the operation mode includes a battery-power activation mode in which the battery is used voltage as the internal power, an RF-power activation mode in which the RF voltage is used as the internal power, a battery charging mode in which the battery is charged by using the RF voltage, and a voltage regulation mode in which a voltage level of the RF voltage is maintained.

16. The RFID tag of claim 15, wherein the internal voltage control circuit determines the operation mode of the RFID block as the battery-power activation mode, the RF-power activation mode, the battery charging mode and the voltage regulation mode in sequence, as the voltage level of the RF voltage increases.

17. The RFID tag of claim 10, wherein the RF voltage detection circuit includes:
a reference voltage generating unit configured to generate a reference voltage;
a comparison voltage generating unit configured to generate a comparison voltage;
an RF voltage comparing unit configured to compare the reference voltage and the comparison voltage; and
an output unit configured to output a comparison result in the RF voltage comparing unit.

18. The RFID tag of claim 10, wherein the RF voltage comparison unit includes a differential amplifier.
